(19) United States
(12) Patent Application Publication
(10) Pub. No.: US 2019/0321852 A1
(43) Pub. Date: Oct. 24, 2019

(54) CONICAL STRUCTURE AND ULTRASONIC TRANSDUCER

(71) Applicant: uBeam Inc., Santa Monica, CA (US)

(72) Inventors: Iman Shahosseini, Woodland Hills, CA (US); Zuki Tanaka, Culver City, CA (US)

(21) Appl. No.: 15/961,087

(22) Filed: Apr. 24, 2018

(51) Int. Cl. B06B 1/06; G10K 13/00

(52) U.S. Cl. CPC B06B 1/067; G10K 13/00; B06B 1/0666

(57) ABSTRACT

An apparatus of the disclosure is directed to conical structure of an ultrasonic transducer. The conical structure may have a first circumference and a second circumference, respectively located at opposite ends of the conical structure, where the first circumference has a greater length than the second circumference. An angle may be formed between a plane including the second circumference and a surface of the conical structure, and a distance may be formed between the first and second circumferences. A rim may be coupled at or adjacent to the first circumference of the conical structure. An ultrasonic transducer may be coupled to the second circumference of the conical structure.

### BACKGROUND

Ultrasonic transducers receive acoustic energy at ultrasonic frequencies as an input and provide electrical energy as an output, or receive electrical energy as an input and provide acoustic energy at ultrasonic frequencies as an output. A structure may be coupled to the ultrasonic transducer to receive or transmit ultrasonic waves. An ultrasonic transducer can include a piece of piezoelectric material that changes size in response to the application of an electric field. If the electric field is made to change at a rate comparable to ultrasonic frequencies, then the piezoelectric element can vibrate and generate acoustic pressure waves at ultrasonic frequencies. Likewise, when the piezoelectric element resonates in response to impinging ultrasonic energy, the element can generate electrical energy.

### BRIEF SUMMARY

Implementations of the disclosed subject matter provide an apparatus that includes a conical structure having a first circumference and a second circumference, respectively located at opposite ends of the conical structure, where the first circumference has a greater length than the second circumference. A rim may be coupled at or adjacent to the first circumference of the conical structure. An ultrasonic transducer may be coupled to the second circumference of the conical structure.

Implementations of the disclose subject matter may provide an apparatus including a conical structure having a first circumference and a second circumference, respectively located at opposite ends of the conical structure, where the first circumference has a greater length than the second circumference. An angle between a plane including the second circumference and a surface of the conical structure may be 165° or greater. The apparatus may include an ultrasonic transducer coupled to the second circumference of the conical structure.

Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an example of a conical structure coupled to an ultrasonic transducer according to an implementation of the disclosed subject matter.

FIG. 1B shows a bottom view of an example ultrasonic transducer according to an implementation of the disclosed subject matter.

FIG. 2 shows a conical structure coupled to an elongated polygon-shaped electrically active material layer according to an implementation of the disclosed subject matter.

FIGS. 3A-3D show side views of an example of a conical structure according to implementations of the disclosed subject matter.

FIGS. 4A-4B show top views of a conical structure according to implementations of the disclosed subject matter.

FIGS. 5A-5B show a cross-section view and a side view, respectively, of an example conical structure having radial ribs according to implementations of the disclosed subject matter.

FIGS. 6A-6B show examples of conical structures having concentric ribs according to implementations of the disclosed subject matter.

FIGS. 7A-7D show example side views of a conical structure having longitudinally disposed circular, oval, rectangular, and polygonal cut-outs according to implementations of the disclosed subject matter.

FIGS. 8A-8D show example side views of a conical structure having horizontally disposed circular, oval, rectangular, and polygonal cut-outs according to implementations of the disclosed subject matter.

FIGS. 9A-9G show example cross-sectional views of rib profiles for a conical structure according to implementations of the disclosed subject matter.

FIG. 10 shows an example of a transducer array according to an implementation of the disclosed subject matter.

### DETAILED DESCRIPTION

Implementations of the disclosed subject matter provide a conical structure coupled to an ultrasonic transducer that has a lower profile and larger opening angle than typical structures that may be coupled to a transducer. The conical structure of the disclosed subject matter may increase the rigidity of the conical structure, and may have a mass below a predetermined amount to decrease eigen-modes. In some implementations, a rim may be added to the conical structure, as well as structural ribs, to increase rigidity. Cutouts may be added to the conical structure to reduce the mass of the conical structure. The shape of the conical structure may be selected to provide acoustic matching between the operating medium (e.g., air) and a transducer.

Implementations of the disclosed subject matter provide a conical structure and a transducer to increase and/or maximize the acoustic pressure of a transmitted signal or signal-to-noise ratio of a received ultrasonic signal, so that an electric signal with decreased noise may be obtained by a receiving device for processing. That is, implementations of the disclosed subject matter provide the conical structure and transducer to generate maximum power from input signals. The conical structure and the transducer may generate a useable signal (even from received low-amplitude signals), regardless of the signal-to-noise ratio of the received signal. In the apparatus of the disclosed subject matter, the surface area of the exposed conical structure may be maximized to capture as much of an incident ultrasonic wave as possible, while having a surface area and/or size of the conical structure be below a predetermined threshold. The surface area of the conical structure may be adjusted by varying the angle between the first and second circumferences of the conical structure, as well as the height and/or the width of a rim attached to the conical structure. In some implementations, the surface area of the conical structure may be adjusted by adding a rim to a portion of the conical structure. These features of the conical structure may be adjusted so as to maximize the surface area to capture as much of an incident ultrasonic wave as possible and generate a useable signal. The thickness of the conical structure can be adjusted based on the selected material of the conical structure to tune the conical structure's stiffness and/or rigidity, so as to improve the acoustic output power for a transmitted signal or signal-to-noise ratio for a received signal. The weight of the conical structure may be adjusted (e.g., based on the selection of materials) so as to minimize a damping effect by the conical structure on the transducer, which may interfere with generating a useable signal.

In some implementations, at least one of the circumferences that defines an opening of the conical structure may be adjusted from a circle shape to an oval shape so as to adjust the focus of the conical structure for a transmitted signal or a received ultrasonic signal. The sidewalls disposed between the circumferences that define the openings of the conical structure may be formed in a planar shape, a convex shape, or a concave shape to adjust the focus of the conical structure for a transmitted signal or a received ultrasonic signal.

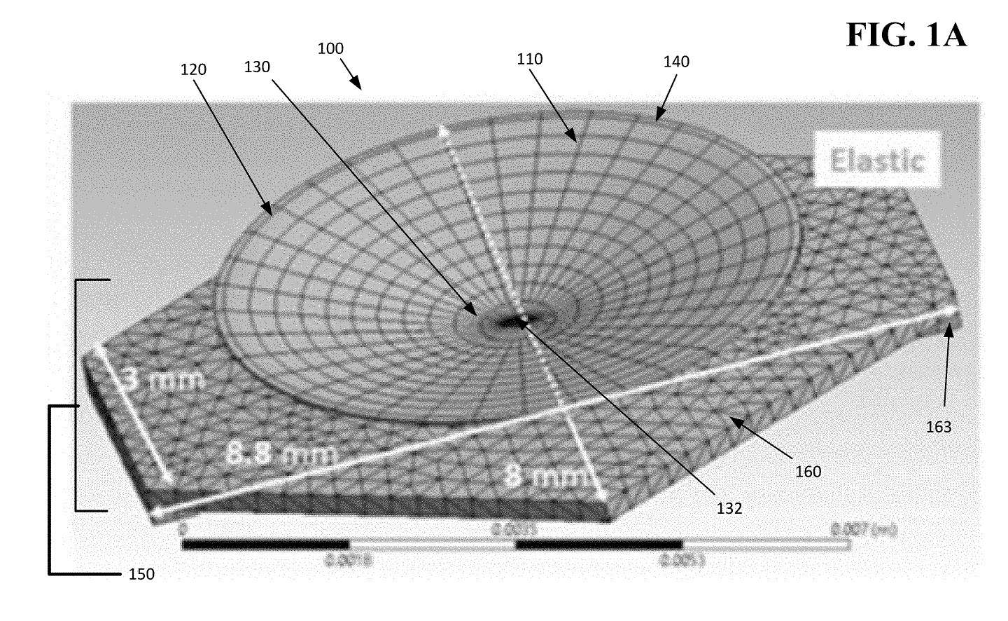

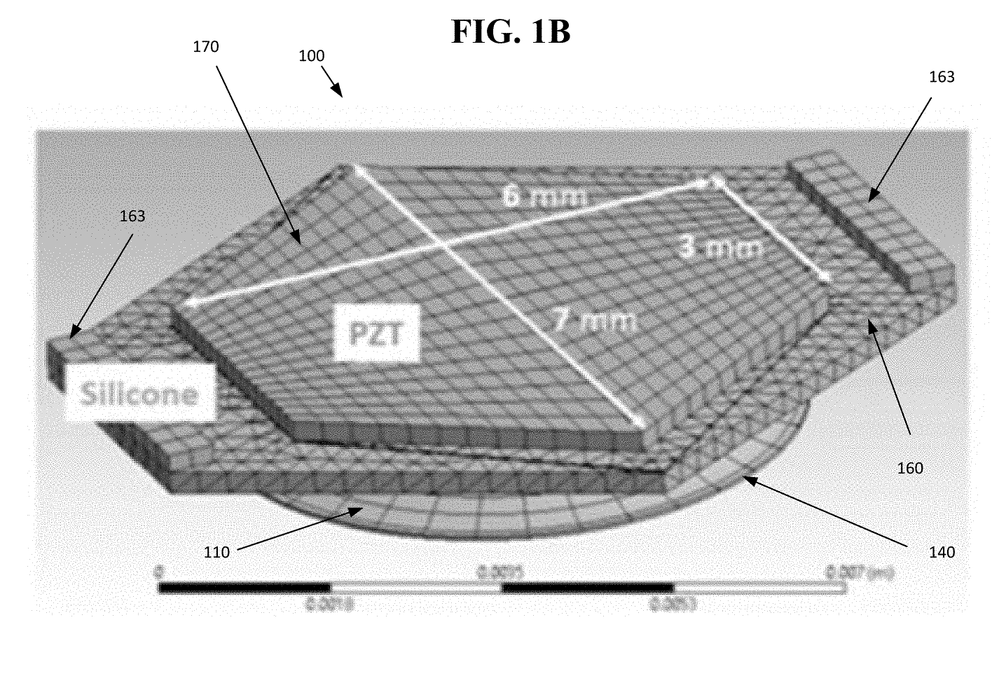

FIGS. 1A-4B show an example of a conical structure coupled to an ultrasonic transducer according to an implementation of the disclosed subject matter. An apparatus 100 may include a conical structure 110 that has a first circumference 120 and a second circumference 130, that are respectively located at opposite ends of the conical structure 110. The conical structure 110 may be formed from steel, stainless steel, aluminum, plastic, carbon fiber composite, or any other suitable material. The conical structure 110 may be formed through any suitable additive or subtractive processes. A rim 140 may be coupled at or adjacent to the first circumference 120 of the conical structure 110. The rim 140 may be formed structurally with the conical structure 110 through the additive or subtractive process. In some implementations, the rim 140 may be formed separately, and then welded, soldered, affixed (e.g., using an adhesive), and/or coupled in any suitable manner to the conical structure 110. The type of coupling used may be selected based on, for example, the type of material used to form the conical structure 110 and/or the rim 140.

The first circumference 120 and the second circumference 130 may be any suitable length. In some implementations, the first circumference of the conical structure 110 may have a length that is 5-10 mm, 10-15 mm, 15-20 mm, 20-25 mm, or 25-30 mm. In some implementations, the first circumference of the conical structure 110 may have a length that is 15-25 mm. The second circumference of the conical structure 110 may have length that is 1-2 mm, 2-3 mm, 3-4 mm, or 4-5 mm. In some implementations, the second circumference of the conical structure 110 may have length that is 2-4 mm.

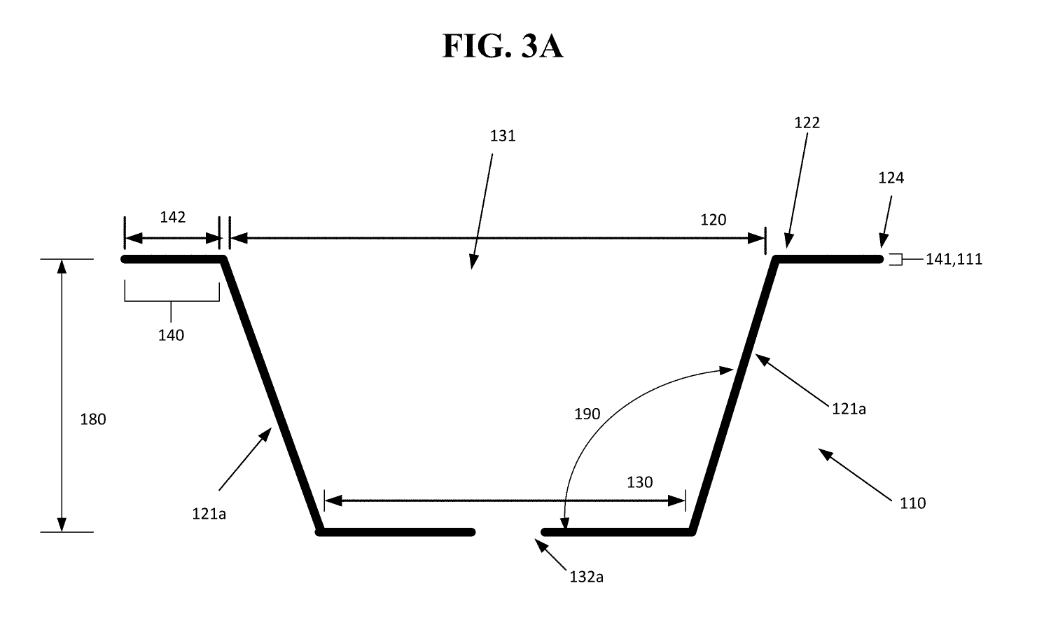

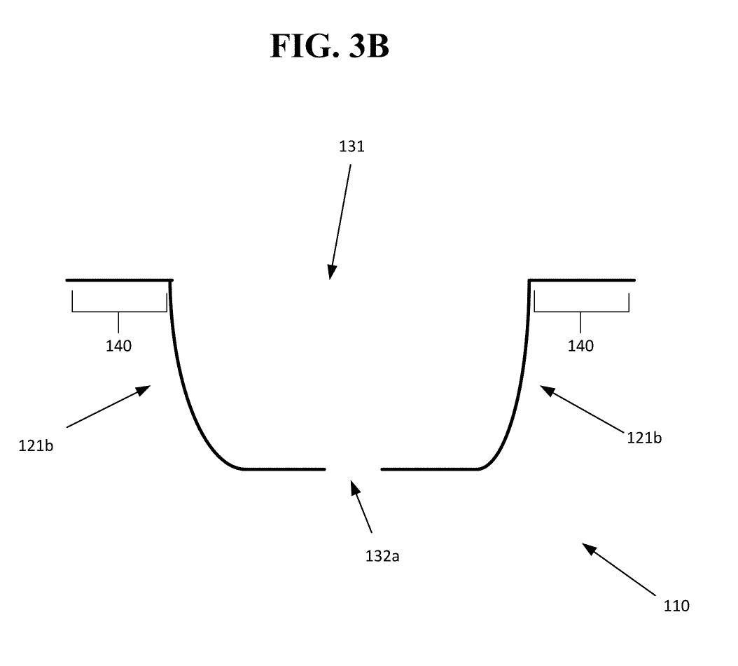

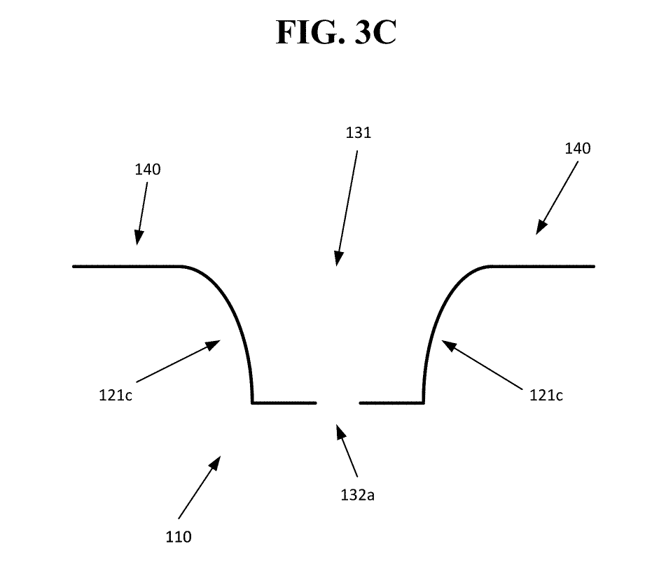

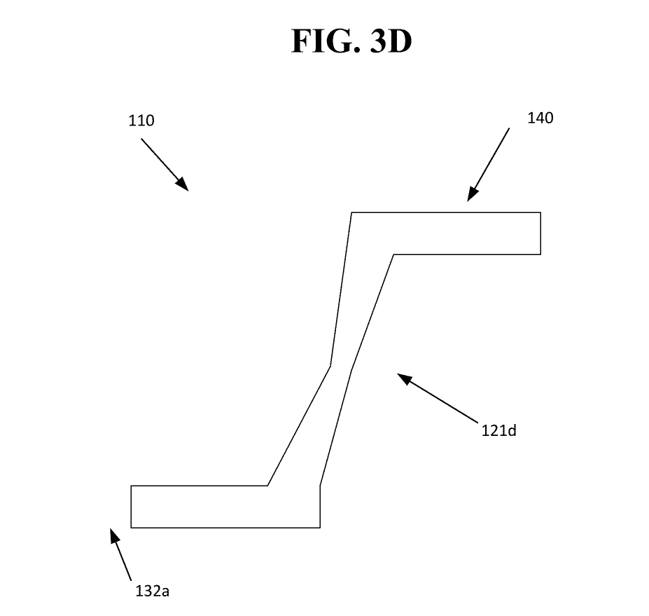

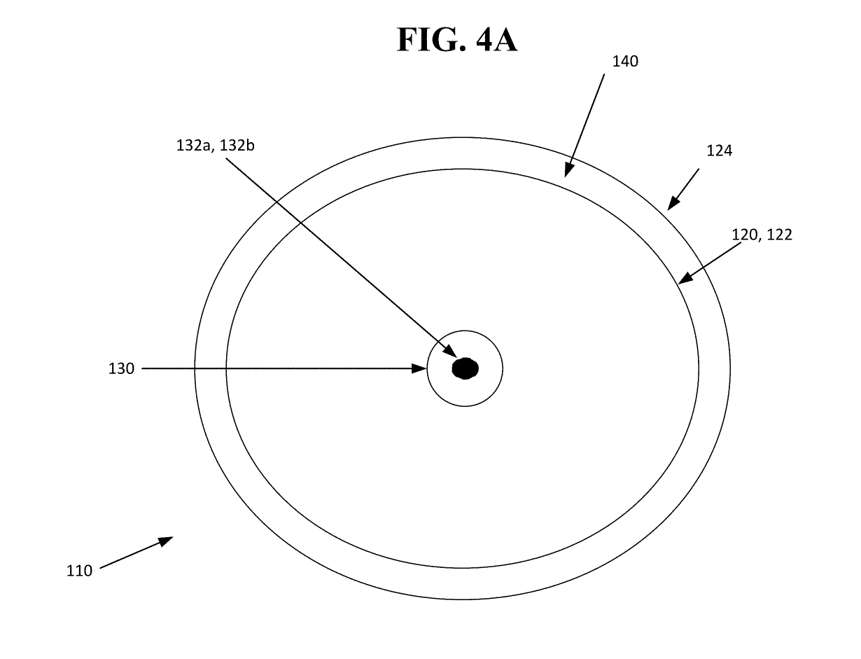

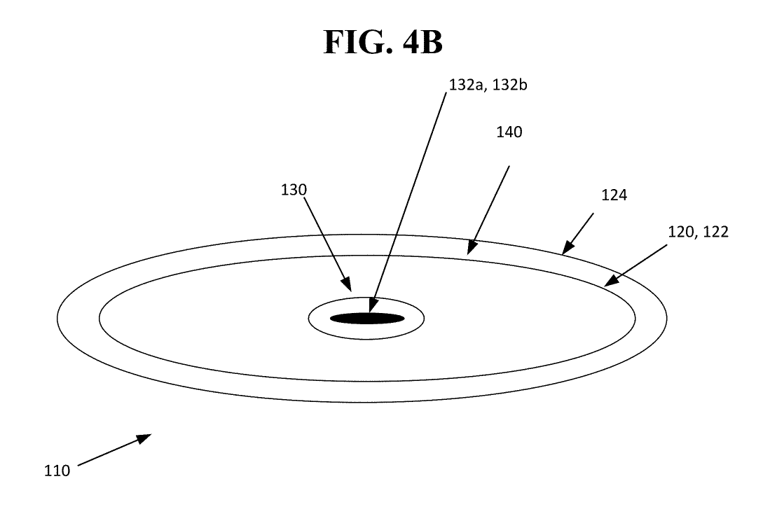

In some implementations, the first circumference 120 and the second circumference 130 may each form openings respectively located at opposite ends of the conical structure 110. The first circumference 120 may form a first opening 131 (e.g., as shown in FIGS. 3A-3C). In some implementations, a second opening may be formed in at least a portion of the area of the second circumference 130 may form a hole 132a (e.g., as shown in FIGS. 3-4). In some implementations, a covering 132b may be formed over the opening formed by the second circumference 130 (e.g., as shown in FIGS. 4A-4B).

The rim 140 of the conical structure 110 shown in FIGS. 1A-4B may have a height 141, which may be 10-30 μm, 30-50 μm, 50-70 μm, 70-90 μm, 90-110 μm, 110-130 μm, 130-150 μm, 150-170 μm, 170-190 μm, or 190-210 μm, or any other suitable height. In some implementations, the height 141 of the rim 140 may be 25-105 μm. A width 142 of the rim 140 may be 0-0.1 mm, 0.1 mm-0.2 mm, 0.2-0.4 mm, and 0.4-0.5 mm, 0.5-0.6 mm, 0.6-0.7 mm, 0.7 mm-0.8 mm, or 0.9-1.0 mm, or any other suitable width. In some implementations, the width 142 of the rim 140 may be 0.01-0.2 mm. The width 142 of the rim may be a distance from an inner rim circumference 122 to an outer rim circumference 124. An inner rim circumference 122 may correspond to that of the first circumference 120 of the conical structure 110.

The thickness 111 of the conical structure 110 may be 10-30 μm, 30-50 μm, 50-70 μm, 70-90 μm, 90-110 μm, 110-130 μm, 130-150 μm, 150-170 μm, 170-190 μm, or 190-210 μm, or any other suitable thickness. In some implementations, the thickness 111 of the conical structure 110 may be 25-105 μm. The thickness 111 may be substantially the same as the height 141 of the rim 140. In some implementations, the thickness of the conical structure 110 may be 90 μm.

A distance 180 may be any suitable distance between the first circumference 120 and the second circumference 130. The distance 180 may be 0.1-0.3 mm, 0.3-0.7 mm, 0.7-1.1 mm, or 1.1-1.5 mm. In some implementations, the distance 180 may be any suitable distance between the first circumference 120 and the second circumference 130 may be 0.7-1.2 mm.

The first circumference 120 may have a greater length than the second circumference 130. An angle 190 between the second circumference 130 and the first circumference 120 may be between a plane including the second circumference and a surface of the conical structure (e.g., as shown in FIG. 3A). The angle 190 between the second circumference 130 and the first circumference 120 may variably increase. In implementations of the disclosed subject matter, the angle 190 may be 150°-170°. This angle 190 of the conical structure 110 may maximize the surface area to capture as much of an incident ultrasonic wave as possible and generate a useable signal.

In some implementations, the angle 190 between the second circumference 130 and the first circumference 120 may be 160° or greater, and the distance 180 between the first circumference 120 and the second circumference 130 may be less than 0.9 mm. In combination with the wider angle 180, implementations where the distance 180 is less than 0.9 may form a conical structure 110 that may maximize the surface area of the conical structure 110 to capture as much of an incident ultrasonic wave as possible and generate a useable signal.

The conical structure 110 may either include or omit the rim 140. The distance 180 between the first circumference 120 and the second circumference 130 may be adjusted, as well as the angle 190 to improve the performance of the conical structure 110 of the apparatus 100. In some implementations, the distance 180 may be 0.9 mm, the angle 190 may be 160°, and the conical structure 110 may include the rim 140. This may improve the signal gain for the apparatus 100 by about 1.7 times, in comparison to a conical structure 110 with similar features that does not have a rim 140 (hereinafter referred to as a reference structure). In some implementations, the distance 180 may be 0.7 mm, the angle 190 may be 165°, and the conical structure 110 may omit the rim 140. This may improve the signal gain for the apparatus 100 by about 2.4 times in comparison to the reference structure. In some implementations, the distance 180 may be 0.7 mm, the angle 190 may be 165°, and the conical structure 110 may include the rim 140. This may improve the signal gain for the apparatus 100 by about 2.9 times in comparison to the reference structure.

FIG. 3A-3D show side views of an example of the conical structure 110 according to implementations of the disclosed subject matter. FIG. 3A shows a planar surface 121a of the conical structure 110 that is disposed between the first circumference 120 and the second circumference 130. FIG. 3B shows a convex surface 121b of the conical structure 110 that is disposed between the first circumference 120 and the second circumference 130. FIG. 3C shows a concave surface 121c of the conical structure 110 that is disposed between the first circumference 120 and the second circumference 130. The surfaces 121a, 121b, and 121c may have a consistent thickness, or may have a variable thickness, such as surface 121d shown in FIG. 3D. The selection of a concave surface or a convex surface may be used to adjust the focus of the conical structure 110 of the apparatus 100 for a transmitted signal or a received ultrasonic signal. The adjustment and/or variation of the thickness (e.g., such as surface 121d shown in FIG. 3D) may be used to adjust the stiffness of the conical structure 110, which may improve the conical structure's stiffness and/or rigidity, so as to improve the acoustic output power for a transmitted signal or signal-to-noise ratio for a received signal.

FIGS. 4A-4B show top views of the conical structure 110 according to implementations of the disclosed subject matter. FIG. 4A shows an implementation of the conical structure 110 that has a circular first circumference 120 and a circular second circumference 130. FIG. 4B shows an implementation of the conical structure 110 that has an oval-shaped first circumference 120 and an oval-shaped second circumference 130. The selection of a circular or oval-shaped first and second circumferences 120, 130 may be used to adjust the focus of the conical structure 110 of the apparatus 100 for a transmitted signal or a received ultrasonic signal. Although FIGS. 4A-4B show pairs of like circular or oval-shaped circumferences, the conical structure 110 may have one circumference (e.g., the first circumference 120) which is oval, and another circumference (e.g., the second circumference 130) which is circular. In some implementations, the conical structure may have at least one circumference (e.g., first circumference 120 and/or second circumference 130 which may be a polygon).

The second circumference 130 of the conical structure 110 may be coupled an ultrasonic transducer 150, which may include an elongated polygon transducer membrane 160 and elongated polygon-shaped electrically active material layer 170, as shown in FIG. 1B. Attachment points 163 (which may be, e.g., silicone) may be disposed on a bottom surface of the elongated polygon transducer membrane 160 (as shown in FIG. 1B) and may be used to attach transducer 150 to a support structure or base. In some implementations, the attachment points 163 may be disposed on a top surface of the elongated polygon transducer membrane 160.

The ultrasonic transducer 150 may be coupled to the conical structure 110 by applying an adhesive, bonding, welding, or soldering, and/or may be coupled in any other suitable manner. The type of coupling used may be selected based on, for example, the type of material used to form the conical structure 110. The elongated polygon-shaped electrically active material layer 170 may be disposed on the elongated polygon-shaped transducer elastic layer 160 to transform electrical excitation into a high-frequency vibration to produce ultrasonic acoustic emissions or transform received high-frequency acoustic vibration into electrical signals.

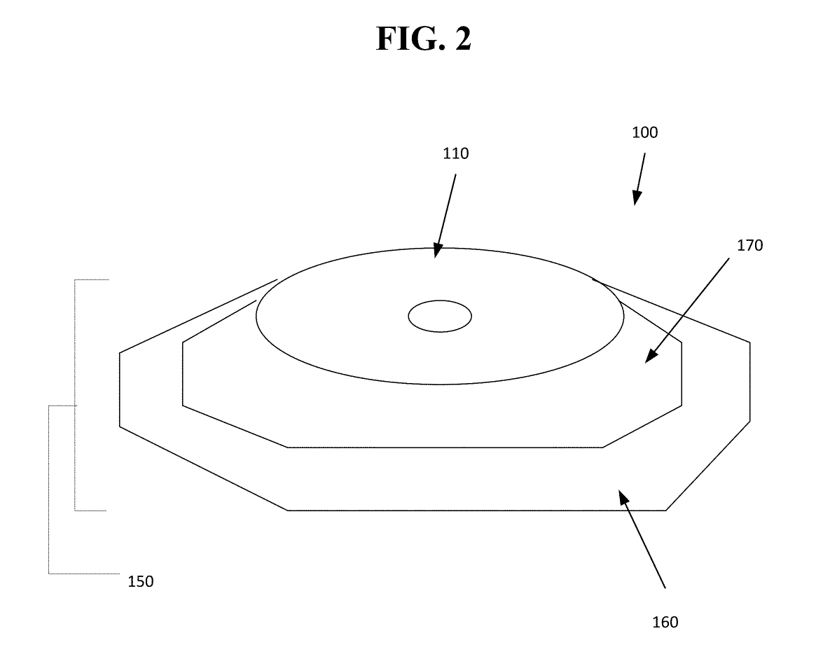

FIGS. 1A-1B show the conical structure 110 coupled to the elongated polygon transducer membrane 160, with elongated polygon-shaped electrically active material layer 170 disposed on the bottom of the elongated polygon transducer membrane 160 according to implementations of the disclosed subject matter. In some implementations, such as shown in FIG. 2, the conical structure 110 may be coupled to the elongated polygon-shaped electrically active material layer 170, and the elongated polygon transducer membrane 160 may be disposed on the bottom of the elongated polygon-shaped electrically active material layer 170.

The ultrasonic transducer 150, as shown in FIGS. 1A-2, may receive an electrical control signal (a “driving signal”), causing the elongated polygon-shaped electrically active material layer 170 (e.g., a flexure to bend and/or the tip) to vibrate relative to its base at or around ultrasonic frequencies. The elongated polygon-shaped electrically active material layer 170 can be in direct or indirect communication with the elongated polygon transducer membrane 160, and can cause the elongated polygon transducer membrane 160 to vibrate and create ultrasonic frequency acoustic waves.

The ultrasonic transducer 150 may include an electromechanically active device, such as the elongated polygon-shaped electrically active material layer 170. The elongated polygon-shaped electrically active material layer 170 may be a cantilever or flexure, and may be, for example, a piezoceramic unimorph, bimorph, or trimorph. The elongated polygon-shaped electrically active material layer 170 may include an electrically active material, such as piezoelectric material or piezo-ceramic, electrostrictive material, or ferroelectric material, which may able to transform electrical excitation into a high-frequency vibration to produce ultrasonic acoustic emissions. The geometry of an elongated polygon-shaped electrically active material layer 170 may affect the frequency, velocity, force, displacement, capacitance, bandwidth, and efficiency of electromechanical energy conversion produced by the electromechanically active device when driven to output ultrasound and the voltage and current generated by the elongated polygon-shaped electrically active material layer 170 and efficiency of electromechanical energy conversion when driven by received ultrasound. The elongated polygon-shaped electrically active material layer 170 may have a hexagonal profile, or may have a profile based on any other suitable geometry. The geometry of the elongated polygon-shaped electrically active material layer 170 may be selected, for example, to tune the balance and other various characteristics of the elongated polygon-shaped electrically active material layer 170. The elongated polygon-shaped electrically active material layer 170 may be made using single layer of piezoelectric material laminated onto a single passive substrate material. The elongated polygon-shaped electrically active material layer 170 may also be made with a single piezoelectric layer and multiple passive layers; two piezoelectric layers operating anti-phase, or two piezoelectric layers, operating anti-phase and combined with one or more electrically passive materials. Different layers of the elongated polygon-shaped electrically active material layer 170 may have different shapes. For example, in a unimorph, a piezoelectric material may be shaped differently from a passive substrate material to which the piezoelectric material is bonded. The piezoelectric material, for example, piezoceramic, used in the electromechanically active device may be poled in any suitable manner, with polarization in any suitable direction.

In some implementations, the polarization direction may be along the thickness of the piezoelectric material (e.g., elongated polygon-shaped electrically active material layer 170). The polarization defines the direction along which the electric field is created in the piezoelectric material once a voltage is applied. The operation mode of the piezoelectric material may be based on how the piezoelectric material is integrated into and/or clamped to a structure. The piezoelectric material may be polarized in the direction of its thickness. As one of the surfaces of the piezoelectric material is polarized along its thickness, and because on one side of the piezoelectric material is attached to the elongated polygon transducer membrane 160, by applying the voltage across the top and bottom side of the piezoelectric material, it deforms and bends up and down (e.g., from a concave shape to a convex shape, and vice-versa).

The elongated polygon-shaped electrically active material layer 170 may be any suitable size for use in the ultrasonic transducer 150, and for vibrating at ultrasonic frequencies. The elongated polygon-shaped electrically active material layer 170 may be made in any suitable manner, such as, for example, by cutting polygon-shaped geometries from a larger laminate material. The laminate material may be made from, for example, an electrically active material, such a piezoceramic, bonded to an electrically inactive substrate, such as, for example, metals such as aluminum, Invar, Kovar, silicon/aluminum alloys, stainless steel, and brass, using any suitable bonding techniques and materials. The materials used may be non-optimal for the performance of an individual electromechanically active device. For example, materials may be selected for consistent performance across a larger number of electromechanically active device or for ease of manufacture.

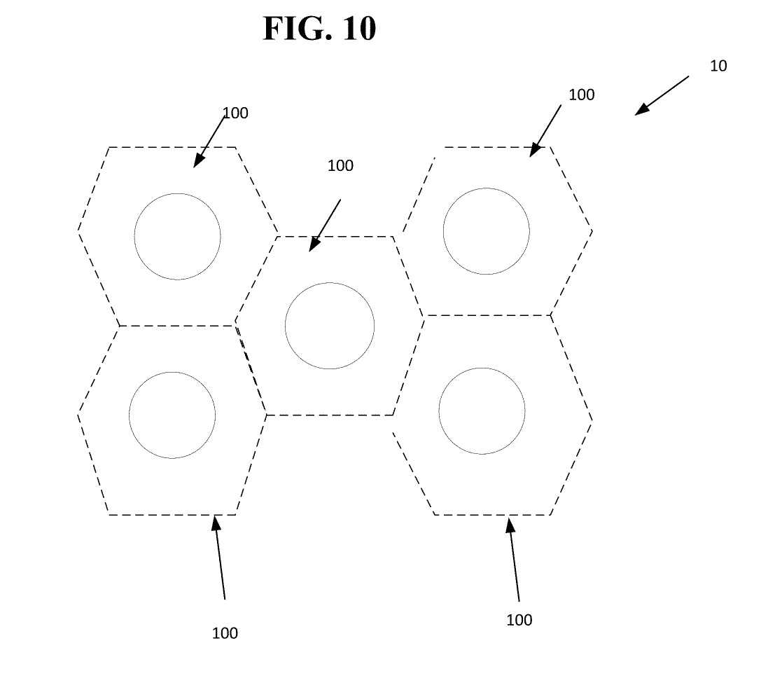

The elongated polygon-shaped electrically active material layer 170 may be oriented at any suitable angle. The top surface of the elongated polygon-shaped electrically active material layer 170, which may be, for example, a passive material of a unimorph or an active material of a bimorph. The elongated polygon-shaped electrically active material layer 170 may be attached to the elongated polygon transducer membrane 160 of an ultrasonic transducer 150 in any suitable manner. For example, any sides of the elongated polygon-shaped electrically active material layer 170 may be bonded to the elongated polygon transducer membrane 160. The bonds used to secure the elongated polygon-shaped electrically active material layer 170 to the elongated polygon transducer membrane 160 may be any suitable combination of organic or inorganic bonds, using any suitable conductive and non-conductive bonding materials, such as, for example, epoxies or solders. The area of contact between the elongated polygon-shaped electrically active material layer 170 and the elongated polygon transducer membrane 160 may be any suitable size and shape. In some implementations, an ultrasonic transducer 150 may include more than one elongated polygon-shaped electrically active material layer 170. As shown in FIG. 10 as disclosed below, any number of ultrasonic transducers may be formed in any suitable arrangement.

The elongated polygon-shaped electrically active material layer 170 may be bonded in a suitable position, with the passive or active layers of the elongated polygon-shaped electrically active material layer 170 facing down depending on whether the electromechanically active device is a unimorph, bimorph, trimorph, or has some other structure. The bond may use any suitable bonding agent, solder, or epoxy. For example, conductive adhesive film may be applied to the areas of the electromechanically active device to be bonded to the elongated polygon transducer membrane 160.

The elongated polygon transducer membrane 160 may be bonded to the ultrasonic transducer 150 to create an ultrasonic device with a membrane. The elongated polygon transducer membrane 160 may be attached with adhesive in a manner that may define the outline of a number of cells of the electromechanical transducer array which the elongated polygon transducer membrane 160 will cover. The elongated polygon-shaped electrically active material layer 170 may be bonded to the elongated polygon transducer membrane 160, for example, at or near the tip of the electromechanically active device. The elongated polygon transducer membrane 160 may be multiple separate pieces of material. The elongated polygon transducer membrane 160 may act to acoustically couple the motion of cantilevers to the air, as the motion of cantilevers may cause the membrane to move.

The elongated polygon transducer membrane 160 may be any suitable material or composite material structure, which may be of any suitable stiffness and weight, for vibrating at ultrasonic frequencies. For example, the elongated polygon transducer membrane 160 may be both stiff and light. For example, the elongated polygon transducer membrane 160 may be aluminum shim stock, metal-patterned Kapton, or any other metal-pattern film. The membrane may be impedance matched with the air to allow for more efficient air-coupling of the ultrasonic transducers.

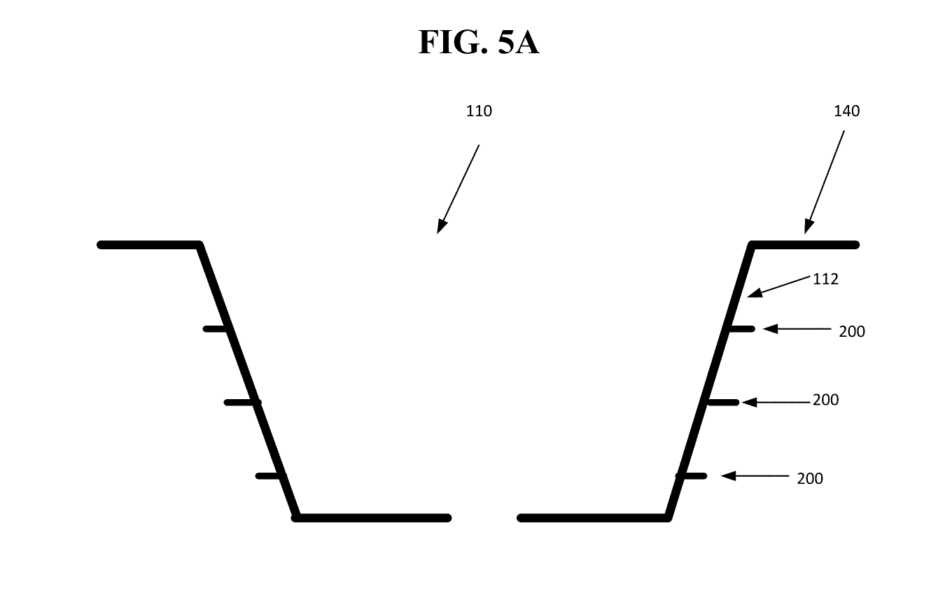

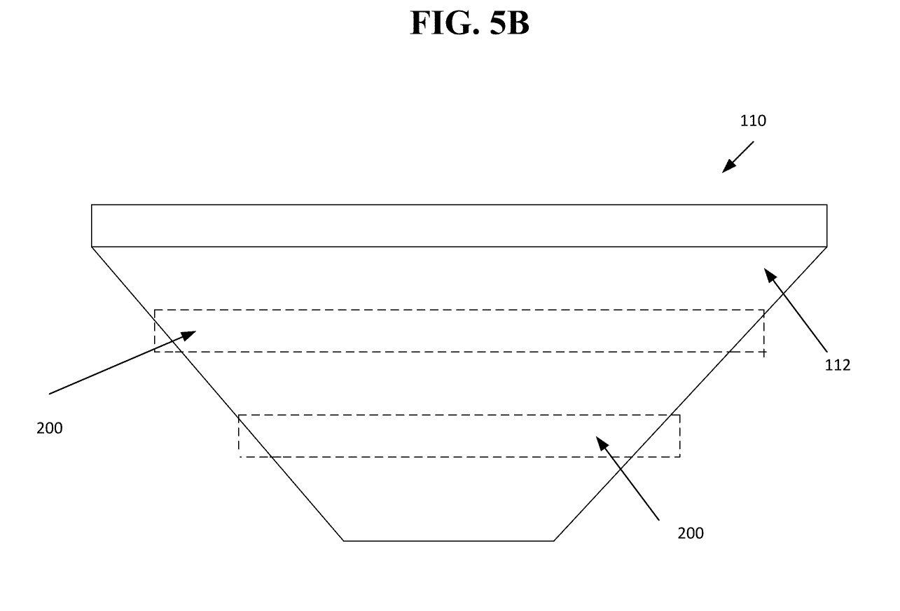

FIGS. 5A-5B show a cross-section view and a side view, respectively, of an example conical structure having radial ribs according to implementations of the disclosed subject matter. The conical structure 110 may have radial ribs 200 disposed on an outer surface 112. The radial ribs 200 may be formed through any suitable additive or subtractive processes. The radial ribs 200 may be bonded, welded, soldered, fixed (e.g., with an adhesive), or coupled in any suitable manner to the outer surface 112 of the conical structure 110. In some implementations, the radial ribs 200 may be integrally formed with the conical structure 110 through any suitable additive or subtractive processes. The radial ribs 200 and/or the rim 140 may have a thickness, profile, structure, and/or placement so as to increase the rigidity of the conical structure 110. The radial ribs 200 and/or the rim 140 may be used to tune the conical structure 110's stiffness and/or rigidity, so as to improve the acoustic output power for a transmitted signal or signal-to-noise ratio for a received signal.

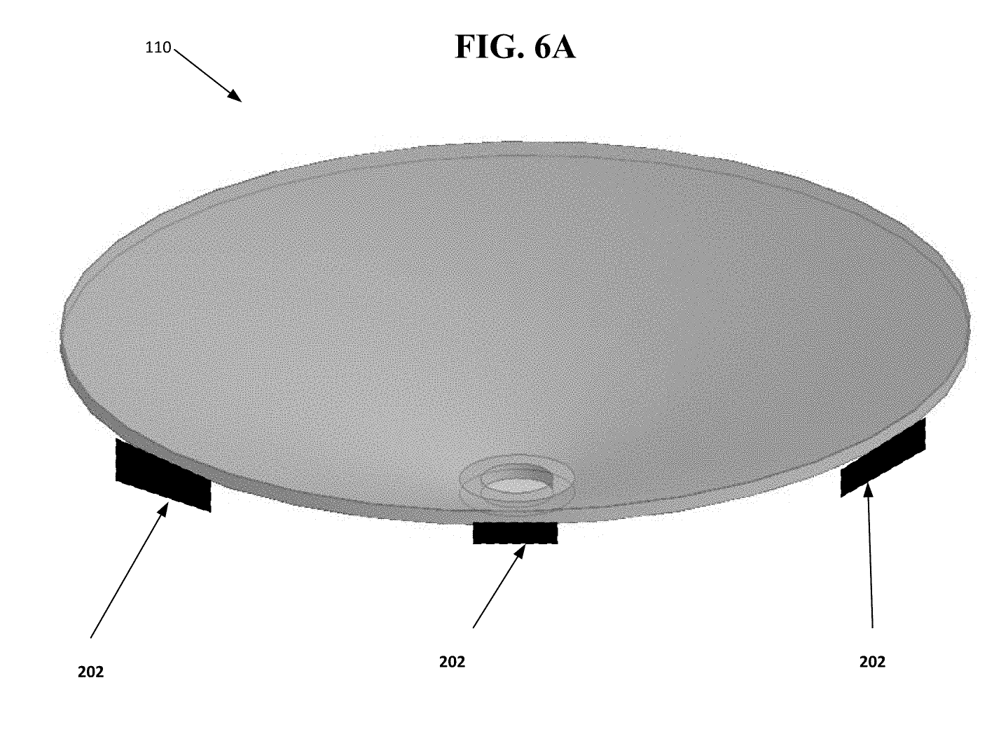

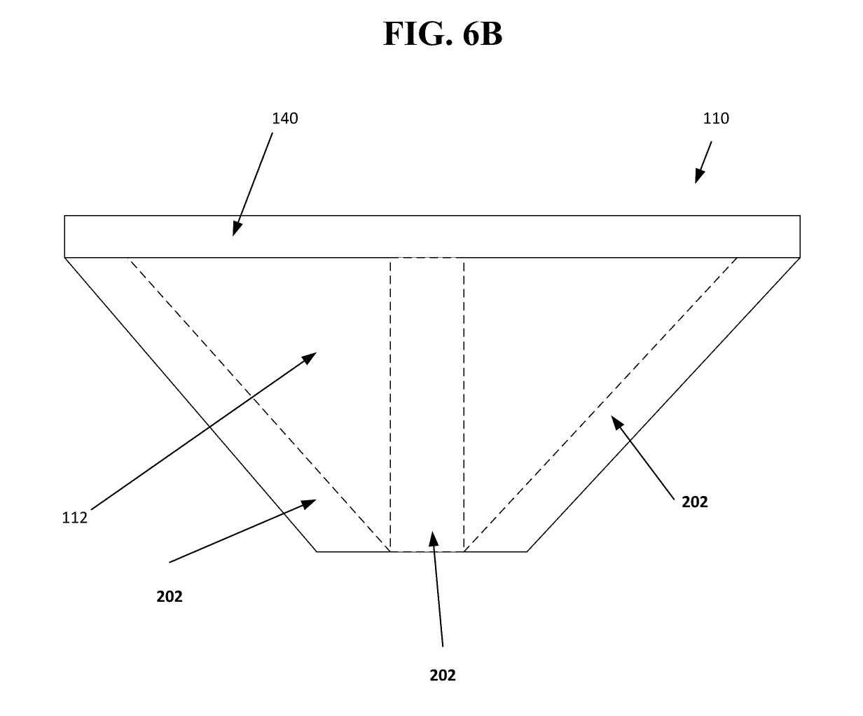

FIGS. 6A-6B show an example of conical structure having concentric ribs according to implementations of the disclosed subject matter. The conical structure 110 may have concentric ribs 202 disposed on an outer surface 112. The concentric ribs 202 may be formed through any suitable additive or subtractive processes. The concentric ribs 202 may be bonded, welded, soldered, fixed (e.g., with an adhesive), or coupled in any suitable manner to the outer surface of the conical structure 110. In some implementations, the concentric ribs 202 may be integrally formed with the conical structure 110 through any suitable additive or subtractive processes. The concentric ribs 202 and/or the rim 140 may have a thickness, profile, structure, and/or placement so as to increase the rigidity of the conical structure 110. The concentric ribs 202 and/or the rim 140 may be used to tune the conical structure 110's stiffness and/or rigidity, so as to improve the acoustic output power for a transmitted signal or signal-to-noise ratio for a received signal.

Adjusting the rigidity of the conical structure 110, such as with the radial ribs shown in FIGS. 5A-5B or with the concentric ribs shown in FIGS. 6A-6B, may at least partially acoustically match the operating medium (e.g., air) and the transducer 150, as well as to assist the transducer 150 in increasing the signal-to-noise ratio so that the transducer 150 may generate a useable signal even from received low-amplitude signals. The ribs (e.g., radial ribs 200 and/or concentric ribs 202) may increase the rigidity of the conical structure 110, so to minimize the cup deformation, while minimizing the added weight to the conical structure 110. Higher energy, such as energy levels above a predetermined threshold, may be converted between an acoustic domain and a mechanical structure (e.g., the transducer 150), resulting in a higher power conversion efficiency.

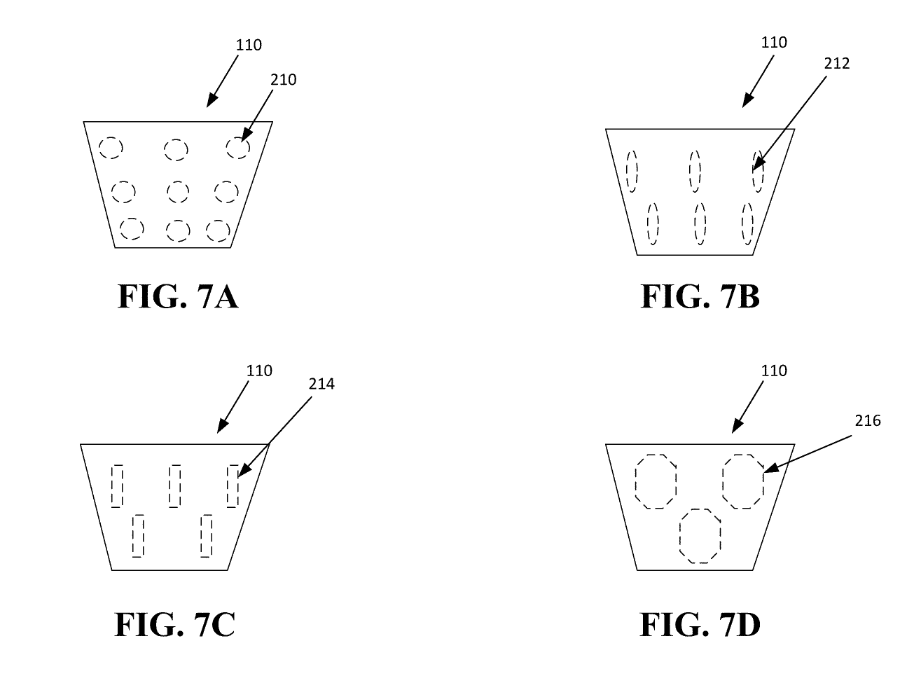

FIGS. 7A-7D show example side views of a conical structure having longitudinally disposed circular, oval, rectangular, and polygonal cut-outs according to implementations of the disclosed subject matter. The conical structure 110 may include at least one cutout disposed longitudinally between the first circumference 120 and the second circumference 130, where the cutout may be a circular cutout (see, e.g., FIG. 7A), an oval cutout (see, e.g., FIG. 7B), a rectangular cutout (see, e.g., FIG. 7C), and a polygon cutout (see, e.g., FIG. 7D). The cutouts shown in FIGS. 7A-7D may be formed, for example, by a subtractive process. The cutouts may be formed in the conical structure 110 so as to reduce weight while maintaining a predetermined threshold of structural rigidity. The weight of the conical structure may be adjusted to minimize a damping effect by the conical structure on the transducer, which may interfere with generating a useable signal.

FIG. 7A shows an example of circular cutouts 210 formed through the thickness 111 of the conical structure 110. The circular cutouts 210 may be formed in a longitudinal direction on the conical structure 110.

FIG. 7B shows an example of oval cutouts 212 formed through the thickness 111 of the conical structure 110. The oval cutouts 212 may be formed in a longitudinal direction on the conical structure 110.

FIG. 7C shows rectangular cutouts 214 that may be formed in a longitudinal direction on the conical structure 110. The rectangular cutouts 214 may be formed through the thickness 111 of the conical structure 110.

FIG. 7D shows polygon cutouts 216 that may be formed in a in a longitudinal direction on the conical structure 110. As an example, the polygon cutouts 216 shown in FIG. 7D may be hexagonal cutouts that may be formed through the thickness 111 of the conical structure 110.

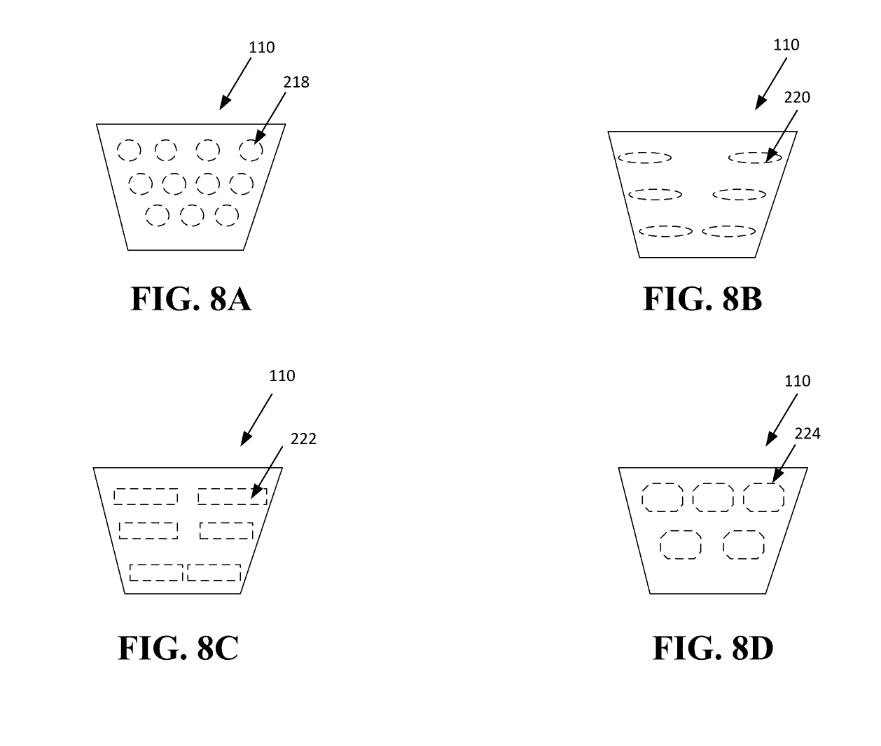

FIGS. 8A-8D show example side views of a conical structure having horizontally disposed circular, oval, rectangular, and polygonal cut-outs according to implementations of the disclosed subject matter. The conical structure 110 may include at least one cutout disposed horizontally between the first circumference 120 and the second circumference 130, where the cutout may be a circular cutout (see, e.g., FIG. 8A), an oval cutout (see, e.g., FIG. 8B), a rectangular cutout (see, e.g., FIG. 8C), and a polygon cutout (see, e.g., FIG. 8D). The cutouts shown in FIGS. 8A-8D may be formed, for example, by a subtractive process. The cutouts may be formed in the conical structure 110 so as to reduce weight while maintaining a predetermined threshold of structural rigidity. The weight of the conical structure 110 may be adjusted to minimize a damping effect by the conical structure 110 on the transducer 150, which may interfere with generating a useable signal. By maintaining the structural rigidity of the conical structure 110, the acoustic output power for a transmitted signal or signal-to-noise ratio for a received signal may be improved.

FIG. 8A shows an example of circular cutouts 218 formed through the thickness 111 of the conical structure 110. The circular cutouts 218 may be formed in a horizontal direction on the conical structure 110.

FIG. 8B shows an example of oval cutouts 220 formed through the thickness 111 of the conical structure 110. The oval cutouts 220 may be formed in a horizontal direction on the conical structure 110.

FIG. 8C shows rectangular cutouts 222 that may be formed in a horizontal direction on the conical structure 110. The rectangular cutouts 222 may be formed through the thickness 111 of the conical structure 110.

FIG. 8D shows polygon cutouts 224 that may be formed in a in a horizontal direction on the conical structure 110. As an example, the polygon cutouts 224 shown in FIG. 8D may be hexagonal cutouts that may be formed through the thickness 111 of the conical structure 110.

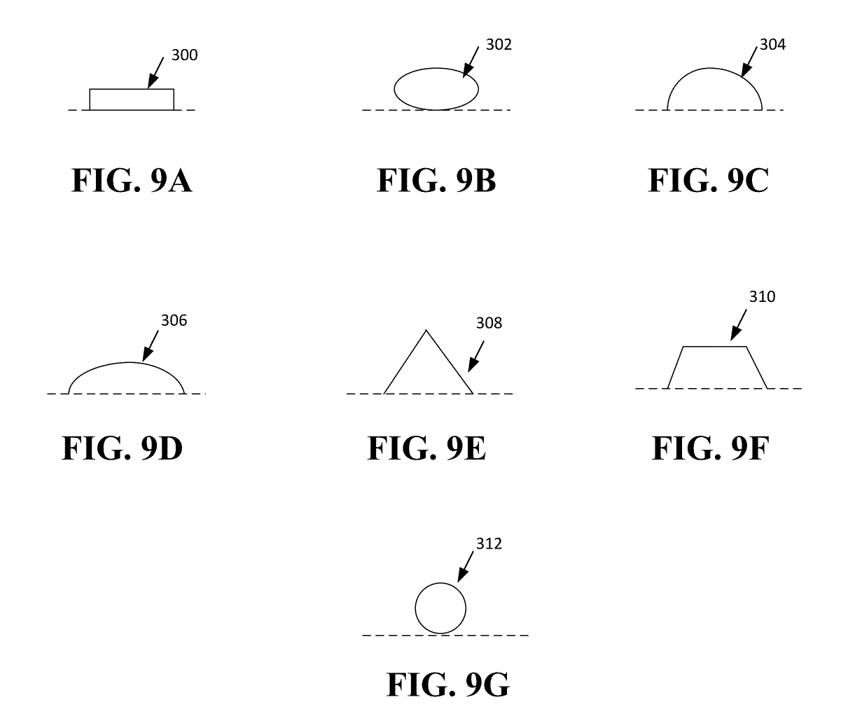

FIGS. 9A-9G show example cross-sectional views of rib profiles for a conical structure according to implementations of the disclosed subject matter. The conical structure 110 may include at least one rib disposed longitudinally or horizontally between the first circumference 120 and the second circumference 130, where the at least one rib may be a rectangular rib, an oval rib, a trapezoidal rib, a tubular rib, a C-shaped rib, a D-shaped rib, and a V-shaped rib. The cross-sectional rib profiles may be used for the radial ribs shown in FIGS. 5A-5B, or with the concentric ribs shown in FIGS. 6A-6B. The different rib profiles shown in FIGS. 9A-9G may add different levels of structural rigidity to the conical structure 110, and may add differing weight to the to the conical structure 110. That is, the rib profile may be selected based on the desired structural rigidity for the conical structure 110, while considering the added weight of the rib profile. By maintaining the structural rigidity of the conical structure 110 using the rib profile, the acoustic output power for a transmitted signal or signal-to-noise ratio for a received signal may be improved.

FIG. 9A shows a rectangular rib profile 300, FIG. 9B shows an oval rib profile 302, FIG. 9C shows a C-shaped rib profile 304, and FIG. 9D shows a D-shaped rib profile 306. FIG. 9E shows a V-shaped rib profile 308, FIG. 9F shows a trapezoid shaped rim profile 310, and FIG. 9G shows a tubular shaped rib profile 312. The rib profiles shown in FIGS. 9A-9G may be formed through any suitable additive or subtractive processes, and may increase the structural rigidity of the conical structure 110. In some implementations, the type of rib profile selected may increase the rigidity of the conical structure more than another type of rib profile.

FIG. 10 shows an example transducer array according to an implementation of the disclosed subject matter. An electromechanical transducer array may include any number of ultrasonic transducers. The ultrasonic transducers may share a common piece of material as a substrate, or may use any suitable number of separate pieces of material, for example, with each ultrasonic transducer having its own separate piece of substrate material. The ultrasonic transducers of an electromechanical transducer array may be divided into cells. Each cell may include a single ultrasonic transducer covered by a membrane or membrane section, or may include multiple ultrasonic transducers. The cells of may be any suitable shape, in any suitable pattern. Cells may be any suitable polygon, and may be arranged in any suitable pattern. For example, as shown in FIG. 10, the transducer array 10 may include a plurality of the apparatus 100 shown in FIG. 1A and disclosed above that include ultrasonic transducers. The ultrasonic transducers may be arranged in any suitable manner, such as, for example, in a grid pattern.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. An apparatus comprising:
a conical structure having a first circumference and a second circumference, respectively located at opposite ends of the conical structure, wherein the first circumference has a greater length than the second circumference;
a rim coupled at or adjacent to the first circumference of the conical structure; and
an ultrasonic transducer coupled to the second circumference of the conical structure.

2. The apparatus of claim 1, wherein an angle between a plane including the second circumference and a surface of the conical structure is 160° or greater.

3. The apparatus of claim 1, wherein an angle between a plane including the second circumference and a surface of the conical structure variably increases.

4. The apparatus of claim 1, wherein a distance between the first circumference and the second circumference of the conical structure is between 0.7-1.2 mm.

5. The apparatus of claim 1, wherein the rim has a height that is between 25-105 μm.

6. The apparatus of claim 1, wherein a thickness of the conical structure is substantially the same as a height of the rim, wherein the thickness is a distance between an inner circumference of the first circumference and an inner circumference of the rim.

7. The apparatus of claim 1, wherein a thickness of the conical structure is varied between the first circumference and the second circumference, wherein the thickness is a distance between an inner circumference of the first circumference and an inner circumference of the rim.

8. The apparatus of claim 1, wherein the rim has a width that is between 0.01-0.2 mm.

9. The apparatus of claim 8, wherein the width of the rim is a distance from an inner circumference of the rim to an outer circumference of the rim.

10. The apparatus of claim 1, wherein at least a shape of an inner circumference of the rim corresponds to that of the first circumference of the conical structure.

11. The apparatus of claim 10, wherein the inner circumference corresponds to the first circumference of the conical structure.

12. The apparatus of claim 1, wherein at least one of the first circumference and the second circumference is selected from the group consisting of: a circle and an oval.

13. The apparatus of claim 1, wherein a thickness of the conical structure is 90 μm.

14. The apparatus of claim 1, wherein the conical structure is formed from at least one of a group consisting of: steel, stainless steel, aluminum, plastic, and carbon fiber composite.

15. The apparatus of claim 1, wherein the conical structure includes at least one cutout disposed longitudinally between the first circumference and the second circumference, wherein the at least one cutout is selected from the group consisting of: a circular cutout, a rectangular cutout, an oval cutout, and a polygon cutout.

16. The apparatus of claim 1, wherein the conical structure includes at least one cutout disposed horizontally between the first circumference and the second circumference, wherein the at least one cutout is selected from the group consisting of: a circular cutout, a rectangular cutout, an oval cutout, and a polygon cutout.

17. The apparatus of claim 1, wherein the conical structure includes at least one rib disposed longitudinally between the first circumference and the second circumference, wherein the at least one rib is selected from the group consisting of: a rectangular rib, an oval rib, a trapezoidal rib, a tubular rib, a C-shaped rib, a D-shaped rib, and a V-shaped rib.

18. The apparatus of claim 1, wherein the ultrasonic transducer is coupled to the conical structure with at least one from the group consisting of: applying an adhesive, bonding, welding, and soldering.

19. The apparatus of claim 1, wherein the first circumference and the second circumference each form openings respectively located at opposite ends of the conical structure.

20. The apparatus of claim 1, wherein the first circumference of the conical structure is 15-25 mm.

21. The apparatus of claim 1, wherein the second circumference of the conical structure is 2-4 mm.

22. The apparatus of claim 1, wherein the second circumference forms an opening.

23. The apparatus of claim 1, wherein a covering is formed over the second circumference.

24. The apparatus of claim 1, wherein a surface of the conical structure disposed between the first circumference and the second circumference is selected from the group consisting of: a convex surface, a concave surface, and a planar surface.

25. The apparatus of claim 1, wherein a surface of the conical structure disposed between the first circumference and the second circumference has a constant thickness or a variable thickness.

26. An apparatus comprising:
a conical structure having a first circumference and a second circumference, respectively located at opposite ends of the conical structure, wherein the first circumference has a greater length than the second circumference, and wherein an angle between a plane including the second circumference and a surface of the conical structure is 165° or greater; and
an ultrasonic transducer coupled to the second circumference of the conical structure.

27. The apparatus of claim 26, wherein a distance between the first circumference and the second circumference of the conical structure is between 0.7-1.2 mm.

28. The apparatus of claim 26, wherein the conical structure further comprises:
a rim coupled at or adjacent to the first circumference of the conical structure that has a height that is between 25-105 μm.

29. The apparatus of claim 28, wherein a thickness of the conical structure is substantially the same as a height of the rim, wherein the thickness is a distance between an inner circumference of the first circumference and an inner circumference of the rim.

30. The apparatus of claim 28, wherein the rim has a width that is between 0.01-0.2 mm, wherein the width of the rim is a distance from an inner circumference of the rim to an outer circumference of the rim.

31. The apparatus of claim 28, wherein at least a shape of an inner circumference of the rim corresponds to that of the first circumference of the conical structure.

32. The apparatus of claim 26, wherein a thickness of the conical structure is varied between the first circumference and the second circumference, wherein the thickness is a distance between an inner circumference and an outer circumference of the first circumference.

33. The apparatus of claim 26, wherein at least one of the first circumference and the second circumference is selected from the group consisting of: a circle, an oval, and a polygon.

34. The apparatus of claim 26, wherein a thickness of the conical structure is 90 μm.

35. The apparatus of claim 26, wherein the conical structure is formed from at least one of a group consisting of: steel, stainless steel, aluminum, plastic, and carbon fiber composite.

36. The apparatus of claim 26, wherein the conical structure includes at least one cutout disposed longitudinally between the first circumference and the second circumference, wherein the at least one cutout is selected from the group consisting of: a circular cutout, a rectangular cutout, an oval cutout, and a polygon cutout.

37. The apparatus of claim 26, wherein the conical structure includes at least one cutout disposed horizontally between the first circumference and the second circumference, wherein the at least one cutout is selected from the group consisting of: a circular cutout, a rectangular cutout, an oval cutout, and a polygon cutout.

38. The apparatus of claim 26, wherein the conical structure includes at least one rib disposed longitudinally between the first circumference and the second circumference, wherein the at least one rib is selected from the group consisting of: a rectangular rib, an oval rib, a trapezoidal rib, a tubular rib, a C-shaped rib, a D-shaped rib, and a V-shaped rib.

39. The apparatus of claim 26, wherein the ultrasonic transducer is coupled to the conical structure with at least one from the group consisting of: applying an adhesive, bonding, welding, and soldering.

40. The apparatus of claim 26, wherein the first circumference of the conical structure is 15-25 mm.

41. The apparatus of claim 26, wherein the second circumference of the conical structure is 2-4 mm.

42. The apparatus of claim 26, wherein the second circumference forms an opening.

43. The apparatus of claim 26, wherein a covering is formed over the second circumference.

44. The apparatus of claim 26, wherein a surface of the conical structure disposed between the first circumference and the second circumference is selected from the group consisting of: a convex surface, a concave surface, and a planar surface.

45. The apparatus of claim 26, wherein a surface of the conical structure disposed between the first circumference and the second circumference has a constant thickness or a variable thickness.
